(19) United States
(12) Patent Application Publication
(10) Pub. No.: US 2009/0067934 A1
(43) Pub. Date: Mar. 12, 2009

(54) PNEUMATIC TRANSPORT SYSTEM AND METHOD OF TRANSPORTING ARTICLES

(76) Inventor: JACK E. BALKO, FARMERS BRANCH, TX (US)

Correspondence Address: HOWISON & ARNOTT, L.L.P, P.O. BOX 741715, DALLAS, TX, 75374-1715, US

(21) Appl. No.: 11/854,443

(22) Filed: Sep. 12, 2007

(51) Int. Cl. B65G 51/16

(52) U.S. Cl. 406/19

(57) ABSTRACT

An apparatus for transporting an article through a conduit includes a conduit extending between a sending station and a receiving station, first and second gates remote from the sending and receiving stations for selectively sealing the conduit between a selected one of the gates and the article, a pressure source connected to the conduit between the first and second gates for selectively exhausting or pressurizing the conduit to create a pressure differential across the article in the conduit, a transfer switch connected to the conduit at a predetermined location between the first and second gates, the transfer switch operative to open and close the first and second gates and actuate the pressure source and wherein the conduit between the article and one of the gates is exhausted to propel the article from the sending station toward the transfer switch and the conduit between the carrier and the other of said gates is pressurized in response to a signal from the transfer switch to propel the carrier away from the transfer switch toward the receiving one of the stations.

### TECHNICAL FIELD

The disclosure and claims presented herein relate to a pneumatic transport system and in particular to a transport system for transporting a carrier between a first station and a second station.

### BACKGROUND

Pneumatic transmission systems are widely known and are used to transmit articles through a conduit or tube from a first station to a second station. Many such systems are used in the banking industry to transport documents between remote drive up stations and tellers working in the bank building. Known pneumatic transport systems are described in U.S. Pat. No. 6,592,302 issued Jul. 15, 2003 to Balko, U.S. Pat. No. 6,039,510 issued Mar. 21, 2000 to Greene et al., U.S. Pat. No. 5,584,613 issued Dec. 17, 1996 to Greene et al., U.S. Pat. No. 4,984,939 issued Jan. 15, 1991 to Foreman et al. and U.S. Pat. No. 4,180,354 issued Dec. 25, 1979 to Greene, the disclosures of which are incorporated herein by reference.

Pneumatic transport systems utilize pressure sources such as blowers or compressors to create a pressure differential across a carrier in the conduit which propels the carrier in the desired direction. The pressure differential may be the result of pressuring the conduit behind the carrier or exhausting the conduit in front of the carrier. If the conduit is pressurized, the conduit in front (direction of travel) of the carrier is open to atmosphere to allow air to escape; if the conduit is exhausted, the conduit behind the carrier is open to atmosphere to allow air to enter the conduit.

Consequently, known pneumatic systems are provided with a pneumatically sealable door or gate at one or both of the sending and receiving stations. These closed station or closed terminal systems require controls and actuating devices at the stations to operate the gates and limit switches or similar devices to insure that the gates at one or both of the stations are in the correct position. In most instances, known systems also utilize separately controlled pressure or vacuum sources at both ends of the conduit for transport. Known systems also rely on elaborate controls, piping and valving to brake or retard a carrier as it approaches a receiving station to prevent the carrier from impacting the station with sufficient force to damage the carrier and/or the station. Thus, there exists a need for a pneumatic transport system that enables the use of open ended stations or terminals thereby eliminating the use of pneumatically sealable gates at the stations and which provides effective braking of a carrier to avoid damage to the receiving station.

### SUMMARY

A pneumatic transport system includes a first station for sending or receiving a carrier, a second station for sending or receiving the carrier and a substantially air tight conduit extending between the first and second stations to convey the carrier between the stations. A transfer switch is operatively connected to the conduit between the first and second stations for generating a signal in response to a carrier passing the switch. The system further includes a first gate for closing the conduit between the first station and the transfer switch, a second gate for closing the conduit between the second station and the transfer switch and a pressure source for selectively exhausting or pressurizing the conduit to create a pressure differential across a carrier in the conduit. A carrier is transported between the stations by exhausting the conduit between the carrier and one of the gates to propel the carrier from the sending station toward the transfer switch. The conduit between the carrier and other of said gates is then pressurized in response to a signal from the transfer switch to propel the carrier away from the transfer switch toward the receiving one of the stations.

In one aspect, a first deceleration switch is operatively connected to the conduit for generating a signal in response to a carrier passing a predetermined location in the conduit between the first gate and the first station and a second deceleration switch is operatively connected to the conduit for generating a signal in response to a carrier passing a predetermined location in the conduit between the second gate and the second station. When a deceleration switch detects a carrier approaching the receiving station, the gate closest to that station is closed in response to a signal from the switch. Closing the gate reduces the pressure in the conduit between the gate and the carrier, reducing the velocity of the carrier before the carrier reaches the receiving station.

In another aspect, the first and second gates comprise disk-shaped slide gates configured for rotation into and out of the conduit. A drive unit or actuator is connected to the first and second gates with a mechanical linkage configured to simultaneously rotate the slide gates in opposite directions in response to a signal from the transfer switch.

The pressure source may be a blower assembly including a single blower and a drive motor for the blower, the assembly being operative in a pressure mode to pressurize the conduit and a vacuum mode to exhaust the conduit. A two way valve may be operatively connected to the transfer switch to switch the blower assembly between the pressure mode and the vacuum mode when a carrier passes the transfer switch. In one embodiment, the pressure source is connected to the conduit adjacent the transfer switch between the first and second gates.

A method of conveying a carrier from a first station wherein the carrier is inserted into a transport conduit to a second station where the carrier is discharged from the conduit includes the steps of: (a) exhausting the conduit through a port between the carrier and a closed second gate to create sub-atmospheric pressure in the conduit between the carrier and the second gate to propel the carrier through the conduit toward the second station, (b) receiving a signal from a transfer switch connected to the conduit at a predetermined location remote from the first and second stations indicating that the carrier has passed the predetermined location, (c) opening the second gate and closing a first gate between the carrier and the first station in response to the signal from the transfer switch, (d) pressurizing the conduit through the port to create super-atmospheric pressure in the conduit between the carrier and the first gate to propel the carrier through the conduit toward the second station; and (e) receiving the carrier from the conduit at the second station.

The method may further include receiving a signal from a deceleration switch connected to the conduit between the transfer switch and the second station, indicating that the carrier is approaching the second station. The second gate is closed in response to the signal to reduce the pressure in the conduit between the second gate and the carrier. The reduction in pressure reduces the velocity of the carrier before the carrier reaches the second station.

### BRIEF DESCRIPTION OF THE DRAWINGS

For a more complete understanding of the apparatus, system and method disclosed herein, and the advantages thereof, reference is now made to the following description taken in conjunction with the accompanying Drawings in which:

FIG. 1 is schematic representation of a pneumatic transport system described herein;

FIG. 2 is a partial schematic representation of a portion of the pneumatic transport system of FIG. 1;

FIG. 3 is partial end schematic of a pneumatic transport system as described herein;

FIG. 4 is a partial side schematic of the transport system of FIG. 3; and

FIG. 5 is a schematic representation of a pressure-vacuum source for use with a pneumatic transport system of the disclosure.

FIG. 6 is a flow chart illustrating one method of pneumatic transport as described herein;

### DETAILED DESCRIPTION

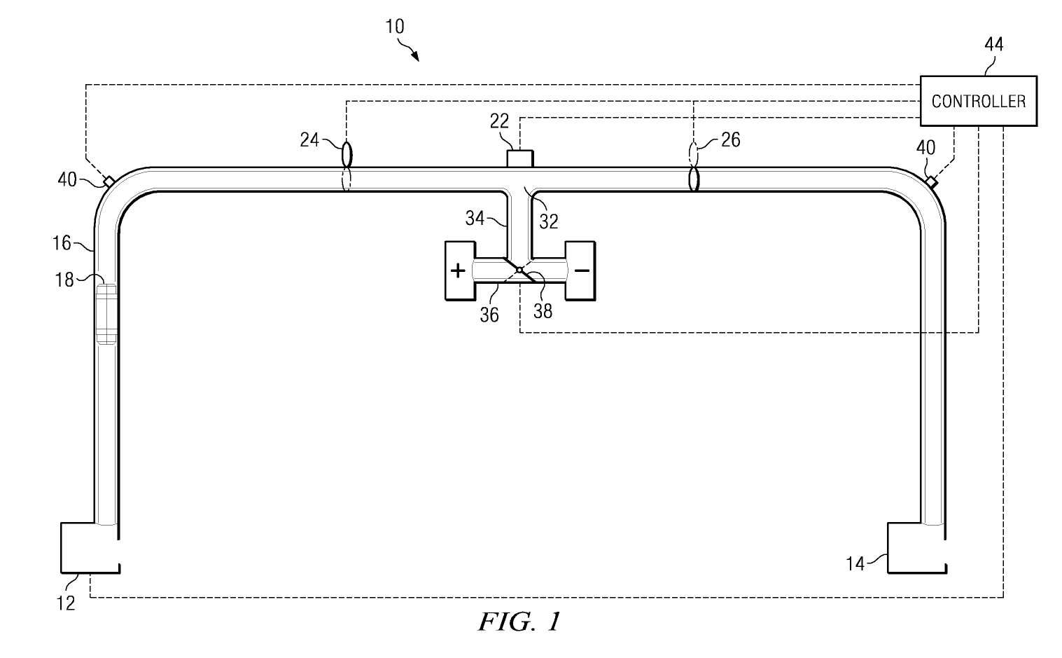

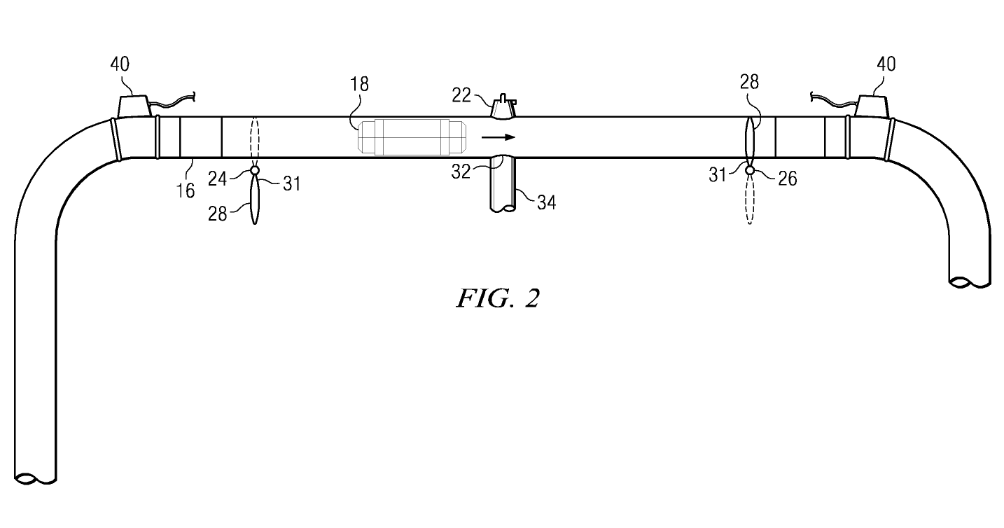

Referring to FIGS. 1 and 2, a pneumatic transport system 10 includes first and second stations 12, 14, a substantially air tight conduit 16 extending between the stations and a carrier 18 that travels between the stations. Conduit 16 is open to atmosphere at both of stations 12, 14. Carrier 18 includes one or more features such as felt collars at the ends thereof to seal between the carrier and the inside surface of conduit 16 so that a pressure differential can be created across the carrier in the conduit. The user places carrier 18 in station 12 or 14 which results in the top of the carrier being positioned in conduit 16 sufficient to be drawn into the conduit completely under sub-atmospheric pressure.

Signals from “SEND” switches on stations 12 and 14 are used to initiate operation of the system. Signals from a transfer switch 22, operatively connected to conduit 16 at a predetermined position between stations 12, 14, are used to control the operation of system 10. Transfer switch 22 is actuated when a carrier 18 passes the switch when traveling through conduit 16. In the illustrated embodiment, transfer switch 22 is connected to conduit 16 midway between gates 24, 26 and approximately midway between stations 12, 14; however, it is contemplated that the switch may be connected at other positions along the conduit.

Transfer switch 22 is operatively connected to a controller 44 that actuates a pair of rotating disk-type slide gates 24, 26 positioned in conduit 16 between the transfer switch and stations 12, 14, respectively. Gates 24, 26 may be positioned at various locations along conduit 16, but remote from stations 12, 14. Gates 24, 26 are remote from stations 12, 14, in that the gates are positioned away from the stations where the terminal ends of conduit 16 are open to atmosphere.

In the closed position, gate 24 isolates the section of conduit 16 between that gate and station 14 from station 12. Similarly, gate 26 may be closed to isolate the section of conduit 16 extending between that gate and station 12 from station 14. In one embodiment, gates 24, 26 are thin plates having a larger disk-shaped first end 28 with a diameter slightly larger than the inside diameter of conduit 16 and a smaller generally triangular end 31 configured for mounting on a rotating operating shaft. In other embodiments, gates 24, 26 may be rectangular, oval or some another geometry. In yet other embodiments gates 24, 26 may be configured and actuated to move in a linear, rather than rotational, direction to open and close.

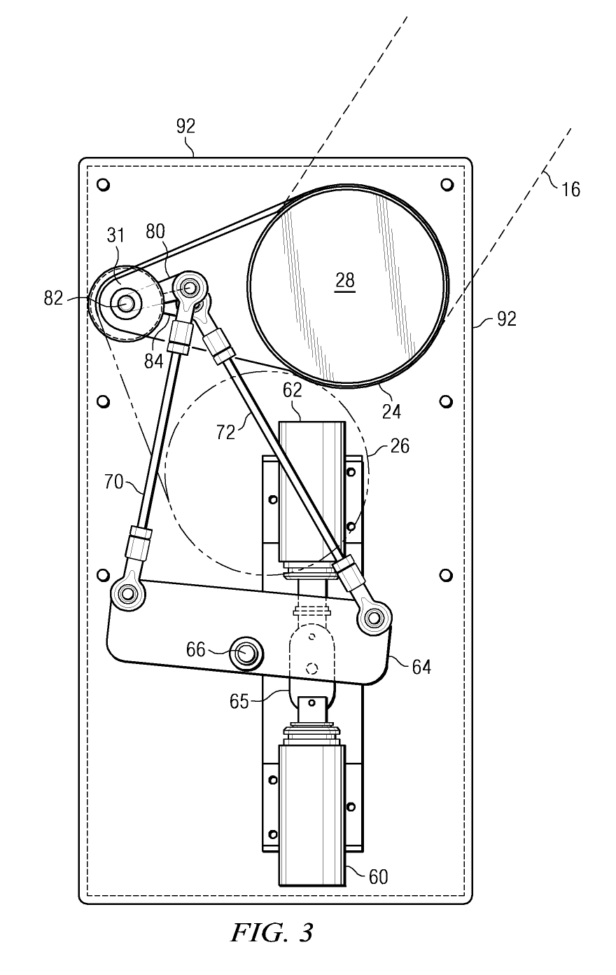

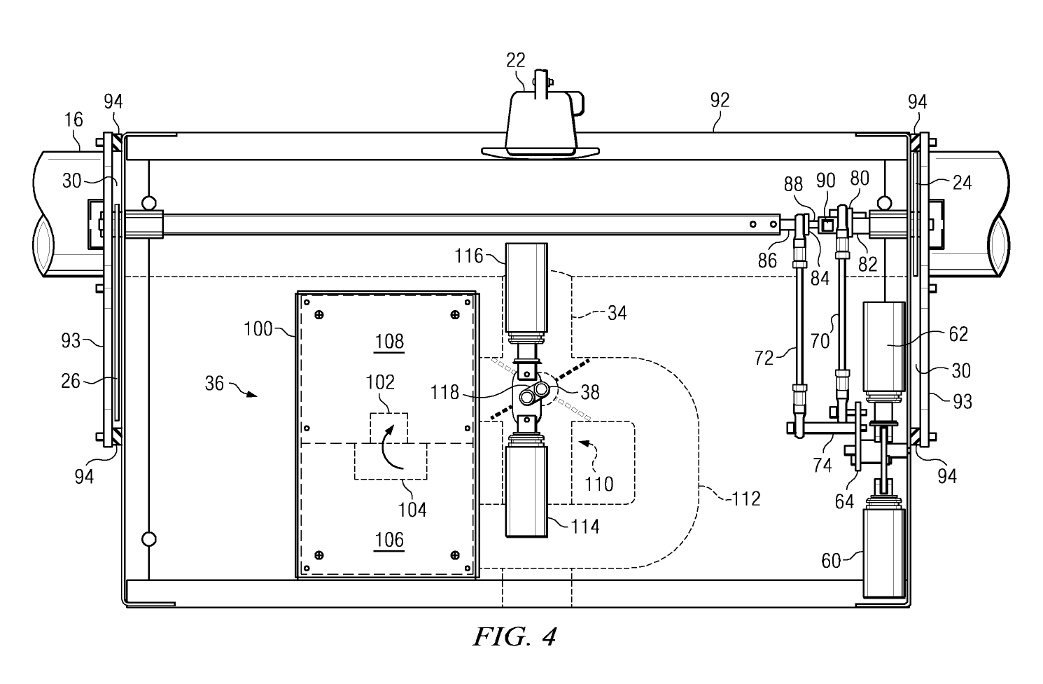

Referring now also to FIG. 3, further details of the gate mechanism are illustrated. The gates 24, 26 have disk-shaped ends 28 that may be selectively positioned within (as shown in solid line) or out of (as shown in phantom line) the bore of the conduit 16 to separate one portion of the conduit from another. In the illustrated embodiment, the gates 24, 26 move within slots 30 (see FIG. 4) formed on either end of the housing 92 by placing a resilient gasket 94 with suitable cut-out section between the housing 92 and end plates 93. In one embodiment, gates 24, 26 are located at positions in conduit 16 adjacent the transfer switch 22.

Conduit 16 is pressurized and exhausted through a pressure tube 34 that connects a pressure/vacuum source 36 to the conduit 16 between gates 24, 26. As described below, in one embodiment, pressure/vacuum source 36 may be a single blower assembly including a blower operating in one direction and a two way valve 38. Alternatively, pressure/vacuum source 36 may be a first blower operating in a pressure mode and a second blower operating in a vacuum mode with associated valves and controls or a single, reversible blower.

Tube 34 opens into conduit 16 at port 32 adjacent to transfer switch 22, signals from which control the operation of two way valve 38 to selectively pressurize or exhaust conduit 16 through tube 34. It is preferred that switch 22 and port 32 be substantially aligned longitudinally within conduit 16. In the illustrated embodiment, port 32 and transfer switch 22 are connected to conduit 16 midway between gates 24, 26. However, in other embodiments, port 32 and switch 22 may be located closer to one of the gates 24, 26 than the other so long as port 32 is positioned between the gates and a distance of not less than one carrier length remains between the port 32 and each of the respective gates 24, 26.

In one embodiment, pressure/vacuum source 36 is a blower or compressor that may be selectively connected to tube 34 and conduit 16 with valve 38 to pressurize or exhaust selected regions of conduit 16 depending upon the location of carrier 18 in the conduit and the positions of gates 24, 26. In one aspect, gates 24, 26 and port 32 are located at positions along conduit 16 such that length and/or volume of conduit 16 between each of the gates and stations 12, 14 furthest from each of the gates are approximately equal.

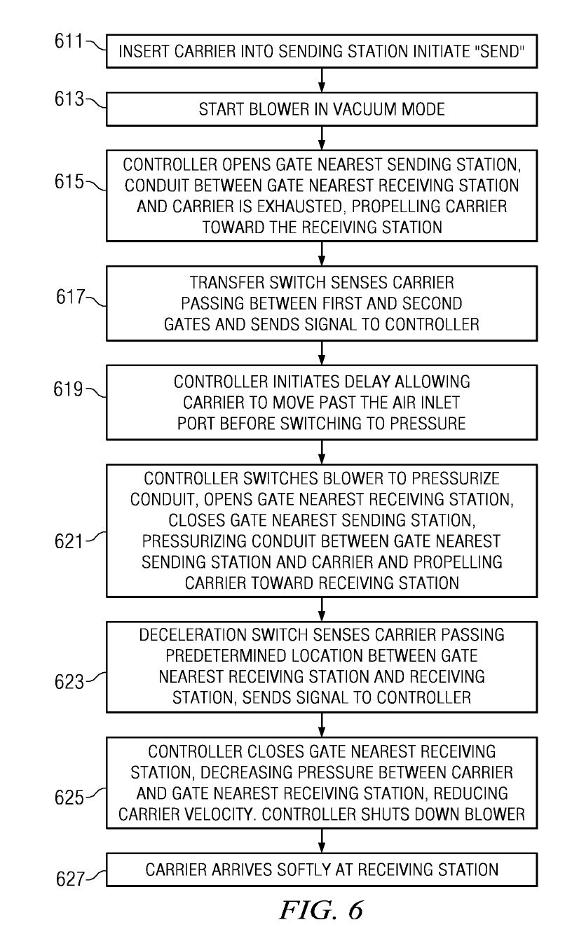

Referring to FIGS. 1 and 6, the transport operation from station 12 to station 14 begins at step 611 with the user placing a carrier 18 into the sending station and initiating the send operation. Gate 26 is closed if not already in the closed position. Controller 44 activates pressure-vacuum source 36 with two way valve 38 in the vacuum position (step 613) and gate 24 is opened if not in the open position. The section of conduit 16 between carrier 18 and gate 26 is exhausted, creating a pressure differential across the carrier that propels the carrier through the conduit (step 615) toward transfer switch 22. FIG. 2 illustrates carrier 18 traveling through conduit 16 as it approaches transfer switch 22.

Transfer switch 22 signals controller 44 when carrier 18 passes the switch. (step 617). In one embodiment, controller 44 may initiate a short delay, on the order of 0.1 seconds, during which air trapped between carrier 18 and gate 26 is compressed, retarding the motion of the carrier through conduit 16 (step 619). After the delay, controller 44 switches two-way valve 38 to the pressurize position (step 621), opens gate 26 and closes gate 24. The section of conduit 16 between gate 24 and carrier 18 is pressurized, propelling the carrier through conduit 16 towards station 14.

In many applications, conduit 16 will include vertical sections or legs adjacent stations 12, 14. In these applications, the force of gravity will tend to accelerate carrier 18 as it approaches the receiving station. To counteract the acceleration due to gravity and insure that carrier 18 and/or stations 12, 14 are not damaged when the carrier reaches the station, a deceleration switch 40 is connected to conduit 16 between transfer switch 22 and station 14. Deceleration switch 40 detects carrier 18 traveling toward station 14 and transmits a signal to controller 44 as the carrier passes the switch (step 623).

Controller 44 actuates gate 26, closing the gate so that pressure in the section of conduit 16 sealed between carrier 18 and gate 26 is reduced as the carrier continues to travel toward station 14 (step 625). Alternatively, a solenoid-operated valve or other quick-acting valve may be closed in the blower assembly, effectively sealing the section of conduit 16 to station 14. In effect, carrier 18 creates a vacuum or sub-atmospheric pressure in conduit 16 between the carrier and gate 26 as it continues to travel through the conduit toward station 14. The reduced pressure brakes or decreases the velocity of carrier 18 before the carrier reaches station 14. The velocity of carrier 18 is reduced to prevent damage and wear to the carrier and receiving station 14 when the carrier arrives at the station.

The send operation is completed with carrier 18 arriving at station 14, completing the send operation (step 627). To send carrier 18 in the reverse direction, the above sequence of steps is repeated with gates 24, 26 being operated in the reverse sequence to accomplish the transfer.

Transfer switch 22 and deceleration switches 40 may be mechanically or pneumatically activated switches, photocells, proximity sensors or any similar switch or sensor that is activated in response to a carrier 18 passing the switch as it travels through conduit. The control functions described above may be accomplished by means of a controller such as a microcontroller, a programmable linear controller, a pre-programmed microprocessor or computer, electromechanical relays, timers and other conventional components generally designated as 44 in FIG. 1.

FIGS. 3 and 4 are schematic representations of an actuating mechanism and linkage for counter-rotational operation of gates 24, 26. In one embodiment, a pair of one-way or single acting solenoids 60, 62, are provided to drive a rocker plate 64 that rotates around a pivot 66 positioned midway along and laterally offset from a central longitudinal axis of the plate. It will be appreciated that a single pivoting shaft or other configurations for rocker arm 64 may be utilized. Solenoids 60, 62 are connected to each other and to rocker plate 64 with a link 65 and are actuated independently from each other, i.e., only one of the solenoids is actuated at a time to drive the rocker plate. A pair of arms 70, 72 are connected to rocker plate 64 adjacent opposite ends of the plate so that rotation of rocker plate 64 drives the arms in opposite directions. As best shown in FIG. 4, arm 72 may be connected to rocker plate 64 with a shaft 74 to offset the arm from the plate to avoid interference with arm 70.

A first link 80 connects arm 70 to a first gate shaft 82 which is connected to the end 31 of gate 24. Similarly, a second link 84 connects arm 72 to a second gate shaft 86 that is connected to the end 31 of gate 26. Shaft 82 includes an axial extending opening 90 at a proximate end that receives a small diameter end 88 of shaft 86 such that the proximate ends (nearest arms 70, 72) of shafts 82, 86 are coaxial, but free to rotate independently of each other. Accordingly, arms 70, 72, links 80, 84 and shafts 82, 86 transmit torque to gates 24, 26, respectively, but not between one another.

While as illustrated, end 88 of gate shaft 86 is received in opening 90 of shaft 82, the proximate ends of first and second gate shafts 82, 86 may be mounted in a bearing block or bushing positioned between links 80, 84 such that the shafts share a common longitudinal axis but do not transmit torque to one another. Bushings or bearings may also be provided at or adjacent the distal ends of shafts 82, 86 to support the shafts.

The use of the above-described linkage to slave the operation of gates 24, 26 together permits the use of a single actuator mechanism to simultaneously operate the gates. Accordingly, actuation of either of solenoids 60, 62 rotates rocker plate 64 to drive arms 70, 72 which operate through links 80, 84 and shafts 82, 86 to simultaneously counter-rotate gates 24, 26. The use of the slaved linkage to counter-rotate gates 24, 26 also permits the drive and linkage to be mounted in an enclosure 92 having a relatively small cross-section since both gates rotate to the same side of conduit 16.

In an alternate variation, gates 24, 26 may be mounted on a single shaft such that the gates rotate in the same direction when actuated, i.e., the gates rotate to both sides of conduit 16. However, a larger enclosure may be required for co-rotating gates since the arc defined by the combined travel of the gates will be larger. Similarly, an alternate drive unit such as a double acting solenoid, electric motor, pneumatic cylinder or other drive may be used in place of single acting solenoids 60, 62. In still other embodiments, the gates may not be mechanically linked to one another. Rather, the operation of gates 24, 26 may be electronically linked and controlled to enable sequential as well as simultaneous operation of the gates as previously described, e.g., FIG. 6.

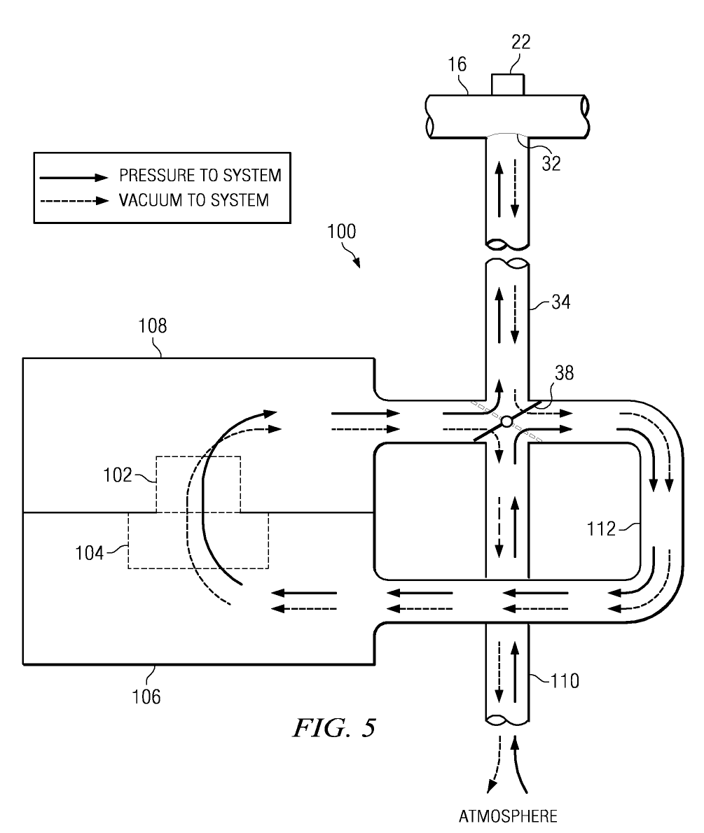

Referring to FIGS. 4 and 5, in one embodiment, pressure source 36 comprises a blower assembly 100 including a blower motor 102 and blower 104. Blower 104 is connected to a vacuum chamber 106 on the inlet side of the blower and a pressure chamber 108 on the outlet side of the blower. Air enters or is discharged from the assembly through an inlet/out pipe 110 that may optionally be provided with a muffler or other sound suppression device.

FIG. 5 illustrates the path of air through blower assembly 100 in the pressure mode (solid arrows) and in the vacuum mode (dashed arrows). In the pressure mode, the two-way valve 38 (shown in solid line) connects the vacuum chamber 106 of the blower assembly 100 to the inlet/outlet pipe 110 and connects the pressure chamber 108 to the port 32. This routes outside air (atmosphere) drawn into the inlet/outlet pipe 110 sequentially through the manifold 112 into the vacuum chamber 106, then through the blower 104 into the pressure chamber 108, then through the tube 34 and port 32 into the conduit 16.

In the vacuum mode, the two-way valve 38 (shown in dotted line) connects the vacuum chamber 106 of the blower assembly 100 to the port 32 and connects the pressure chamber 108 to the inlet/outlet pipe 110. This routes air drawn from the conduit 16 of the system through port 32 and tube 34 sequentially into the manifold 112, into the vacuum chamber 106, through the blower 104 into the pressure chamber 108, then through the inlet/outlet pipe 110 to the atmosphere. Note that in the embodiment shown in FIG. 5, the direction of air flow through blower 104 and the manifold 112 does not change when switching between pressure and vacuum modes. This allows the illustrated system to use a single blower 104 running in the same direction for both pressure and vacuum modes; thereby avoiding the need for multiple blowers (more cost) or the need to reverse the direction of the blower (more time to switch and more maintenance).

A pair of one-way (i.e., single acting) solenoids 114, 116, controlled by controller 44, drive two-way valve 38 between the pressure and vacuum positions. Solenoids 114, 116 are connected to valve 38 with a link 118 and are independently actuated to drive the valve to the pressure or vacuum positions. Alternatively, a double-acting solenoid, electric motor, pneumatic cylinder or other drive unit may be used in place of single-acting solenoids 114, 116. In other embodiments, a blower assembly that reverses motor and blower direction to switch between pressure and vacuum modes may be used. In still other embodiments, separate pressure and vacuum sources may employed.

The pneumatic system disclosed herein provides an apparatus for conveying a carrier through a conduit open to atmosphere at the sending and receiving stations. The system oblviates the need for sealed gates or doors at the stations, the associated controls, limit switches and drives for such gates. The system also provides for decelerating a carrier approaching the receiving station without special controls, valves and piping.

The drawings and detailed description herein are to be regarded in an illustrative rather than a restrictive manner, and are not intended to limit the following claims to the particular forms and examples disclosed. On the contrary, further modifications, changes, rearrangements, substitutions, alternatives, design choices, and embodiments will be apparent to those of ordinary skill in the art. Thus, it is intended that the following claims be interpreted to embrace all such further modifications, changes, rearrangements, substitutions, alternatives, design choices, and embodiments.

What is claimed is:

1. A pneumatic transport system comprising;
first station for sending or receiving a carrier;
a second station for sending or receiving the carrier;
a conduit extending between the first and second stations to convey the carrier between the stations;
a transfer switch operatively connected to the conduit between the first and second stations for generating a signal in response to a carrier passing the switch;
a first gate for closing the conduit between the first station and the transfer switch;
a second gate for closing the conduit between the second station and the transfer switch, wherein the transfer switch is operatively connected to the conduit between the first and second gates;
a pressure source for selectively exhausting or pressurizing the conduit to create a pressure differential across a carrier in the conduit; and,
wherein the conduit between the carrier and one of the gates is first exhausted to propel the carrier from a sending one of the stations toward the transfer switch and the conduit between the carrier and other of said gates is then pressurized in response to a signal from the transfer switch to propel the carrier away from the transfer switch toward a receiving one of the stations.

2. The system of claim 1 further comprising
a first deceleration switch operatively connected to the conduit for generating a signal in response to a carrier passing a predetermined location in the conduit between the first gate and the first station;
a second deceleration switch operatively connected to the conduit for generating a signal in response to a carrier passing a predetermined location in the conduit between the second gate and the second station; and
wherein the gate closest to the receiving station is closed in response to a signal from the deceleration switch nearest the receiving station to reduce the pressure in the conduit between the closed gate and the carrier and reduce the velocity of the carrier before the carrier reaches the receiving station.

3. The system of claim 1 wherein the first and second gates comprise slide gates configured for movement into and out of the conduit.

4. The system of claim 3 further comprising a drive unit connected to the first and second gates with a linkage configured to simultaneously move the slide gates in opposite directions in response to a signal from the transfer switch.

5. The system of claim 1 further comprising a mechanical linkage that slaves the operation of the first gate to the operation of the second gate.

6. The system of claim 1 further comprising an actuator and linkage for driving the first and second gates in opposite rotational directions in response to a signal from the transfer switch.

7. The system of claim 1 wherein the pressure source is a blower assembly operative in a pressure mode to pressurize the conduit and a vacuum mode to exhaust the conduit.

8. The system of claim 7 further comprising a two way valve for switching the pressure source between the pressure mode and the vacuum mode.

9. The system of claim 8 wherein the transfer switch is operatively connected to the two way valve for switching between the vacuum mode and the pressure mode when a carrier passes the transfer switch.

10. The system of claim 1 wherein the pressure source is connected to the conduit adjacent the transfer switch.

11. The system of claim 1 wherein the pressure source comprises a single blower operating in one direction for a pressure mode to pressurize the conduit and a vacuum mode to exhaust the conduit.

12. A method of transmitting a carrier from a first station wherein the carrier is inserted into a transport conduit to a second station where the carrier is discharged from the conduit, the method comprising:
exhausting the conduit between the carrier and a closed second gate to create sub-atmospheric pressure in the conduit between the carrier and the second gate to propel the carrier through the conduit toward the second station;
receiving a signal from a transfer switch connected to the conduit at a predetermined location remote from the first and second stations, indicating that the carrier has passed the predetermined location;
opening the second gate and closing a first gate between the carrier and the first station in response to the signal from the transfer switch;
pressurizing the conduit between the carrier and the first gate to create super-atmospheric pressure in the conduit between the carrier and the first gate to propel the carrier through the conduit toward the second station; and
receiving the carrier from the conduit at the second station.

13. The method of claim 12 further comprising receiving a signal from a deceleration switch indicating that the carrier is approaching the second station; and
closing the second gate to seal the conduit between the second gate and the carrier and reduce the pressure in the conduit between the second gate and the carrier to decelerate the carrier.

14. The method of claim 12 wherein the deceleration switch is connected to the conduit between the second gate and the second station.

15. The method of claim 12 wherein the step of opening the second gate and closing a first gate between the carrier and the station in response to the signal from the transfer switch further comprises energizing an actuator to simultaneously open the second gate and close the first gate.

16. The method of claim 15 wherein the actuator drives a linkage to counter-rotate the first and second gates.

17. The method of claim 12 wherein the step of exhausting the conduit between the carrier and a closed second gate to create sub-atmospheric pressure in the conduit between the carrier and the second gate to propel the carrier through the conduit toward the second station comprises actuating a valve in response to a signal from the transfer switch to connect the conduit to a vacuum source.

18. The method of claim 12 wherein the step of pressurizing the conduit between the carrier and the first gate to create super-atmospheric pressure in the conduit between the carrier and the first gate to propel the carrier through the conduit toward the second station comprises actuating a valve in response to a signal from the transfer switch to connect the conduit to a pressure source.

19. An apparatus for transporting an article through a conduit comprising;
a conduit extending between a sending station and a receiving station;
first and second gates remote from the sending and receiving stations for selectively sealing the conduit between a selected one of the gates and the article;
a pressure source connected to the conduit between the first and second gates for selectively exhausting or pressurizing the conduit to create a pressure differential across an article in the conduit;
a transfer switch connected to the conduit at a predetermined location between the first and second gates, the transfer switch operative to open and close the first and second gates and actuate the pressure source; and
wherein the conduit between the article and one of the gates is exhausted to propel the article from the sending station toward the transfer switch and the conduit between the carrier and the other of said gates is pressurized in response to a signal from the transfer switch to propel the carrier away from the transfer switch toward the receiving one of the stations.

20. The apparatus of claim 19 further comprising a mechanical linkage for simultaneously operating the first and second gates.

21. The apparatus of claim 19 where the predetermined location is substantially midway between the sending station and the receiving station.

22. The apparatus of claim 19 wherein the pressure source comprises a single blower operating in one direction for a pressure mode to pressurize the conduit and a vacuum mode to exhaust the conduit.
